(19) United States
(12) Patent Application Publication
(10) Pub. No.: US 2026/0356382 A1
(43) Pub. Date: Nov. 12, 2026

(54) VEHICLE PARK-ASSIST SYSTEMS

(71) Applicant: GM Global Technology Operations LLC, Detroit, MI (US)

(72) Inventors: Alexander Bower, Ann Arbor, MI (US); Alec M. Wuorinen, Columbus, OH (US); Russell A. Patenaude, Macomb Township, MI (US); Matthew Edward Gilbert-Eyres, Rochester Hills, MI (US)

(73) Assignee: GM Global Technology Operations LLC, Detroit, MI (US)

(21) Appl. No.: 19/201,312

(22) Filed: May 7, 2025

(51) Int. Cl. B60W 50/08; B60W 10/04; B60W 10/18; B60W 50/14; B62D 1/04

(52) U.S. Cl. CPC B60W 50/082; B60W 10/04; B60W 10/18; B60W 50/085; B60W 50/14; B60W 2510/10; B60W 2520/10; B60W 2540/10; B60W 2540/215; B60W 2554/80; B60W 2710/0677; B60W 2710/086; B62D 1/046

(57) ABSTRACT

A method includes determining that an operator of a vehicle is performing a parking maneuver. The method also includes, based on determining that the operator is performing the parking maneuver, determining that a park-assist mode for the vehicle is enabled. The method further includes, based on determining that the park-assist mode for the vehicle is enabled, decreasing a sensitivity of a throttle of the vehicle such that the operator has to provide a greater actuation of a throttle actuator to affect a same power of an engine of the vehicle. The engine may include an internal combustion engine or an electric motor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Navigating a vehicle in a parking lot or garage can be challenging for an operator of the vehicle due to several factors. For example, confined spaces and narrow lanes often leave little room for maneuvering, making it difficult to execute turns or parking maneuvers (e.g., entering or exiting a parking space). Additionally, navigating a parking lot or garage may require fine throttle control by the operator in order to inch a vehicle forward or backward. Also, with all that the operator has to consider while navigating a parking lot or garage, the operator may inadvertently select a wrong gear.

The present disclosure relates generally to vehicle park-assist systems.

### SUMMARY

One aspect of the disclosure provides a vehicle including an engine, a throttle, a throttle actuator, data processing hardware, and memory hardware in communication with the data processing hardware. The engine may be an electric motor or an internal combustion engine. The throttle actuator is configured to, responsive to user input from an operator of the vehicle, controls the throttle to adjust a power of the engine for propelling the vehicle. The memory hardware stores instructions that, when executed by the data processing hardware, cause the data processing hardware to perform operations. The operations include determining that the operator is performing a parking maneuver, based on determining that the operator is performing the parking maneuver, determining that a park-assist mode for the vehicle is enabled, and, based on determining that the park-assist mode for the vehicle is enabled, decreasing a sensitivity of the throttle such that the operator has to provide a greater actuation of the throttle actuator to affect a same power of the engine.

Implementations of the disclosure may include one or more of the following optional features. In some implementations, the operations also include temporarily designating a steering wheel button for receiving a user input representing a decreased sensitivity amount for the throttle, and decreasing the sensitivity of the throttle based on the user input. In some examples, determining that the park-assist mode for the vehicle is enabled includes at least one of prompting the operator to enable the park-assist mode, or obtaining a setting of the vehicle that indicates whether the park-assist mode is enabled.

In some examples, determining that the operator of the vehicle is performing the parking maneuver is based on one or more inputs representative of one or more of a distance to a neighboring vehicle, an orientation of the vehicle relative to a neighboring vehicle, a position of the vehicle relative to a parking space boundary, a geographic location of the vehicle, a speed of the vehicle, a proximity of the vehicle to at least one of a point-of-interest or a navigation destination, or a gear of the vehicle. Determining that the operator of the vehicle is performing the parking maneuver may include obtaining the one or more inputs using one or more sensors of the vehicle, and processing, using a machine learning (ML) model, the one or more inputs to determine whether the operator is performing the parking maneuver.

In some implementations, the operations also include determining whether the operator provided a user input representing a decreased sensitivity amount for the throttle, based on determining that the operator provided the user input, decreasing the sensitivity of the throttle based on the user input, and, based on determining that the operator did not provide the user input, decreasing the sensitivity of the throttle based on a default decreased sensitivity amount. In some examples, the operations also include, based on determining that the park-assist mode for the vehicle is enabled, increasing an autobrake sensitivity.

In some examples, the operations also include, when the parking maneuver includes navigating the vehicle out of a parking spot, determining a previous gear of the vehicle used to park the vehicle in the parking spot, determining a current gear of the vehicle, and, when the previous gear matches the current gear, alerting the operator that the previous gear matches the current gear, and prompting the operator to confirm the current gear. In some implementations, the operations also include determining, based on a current gear of the vehicle, an intended direction of movement for the vehicle, determining that there is less than a first pre-determined amount of open space in the intended direction of movement and at least a second pre-determined amount of open space opposite the intended direction of movement, and, based on determining that there is less than a first pre-determined amount of open space in the intended direction of movement and at least a second pre-determined amount of open space opposite the intended direction of movement, alerting and prompting the operator to confirm the current gear.

Another aspect of the disclosure provides a method includes determining that an operator of a vehicle is performing a parking maneuver, based on determining that the operator is performing the parking maneuver, determining that a park-assist mode for the vehicle is enabled, and, based on determining that the park-assist mode for the vehicle is enabled, decreasing a sensitivity of a throttle of the vehicle such that the operator has to provide a greater actuation of a throttle actuator to affect a same power of an engine of the vehicle. The engine may be an electric motor or an internal combustion engine.

Implementations of the disclosure may include one or more of the following optional features. In some implementations, the method also includes temporarily designating a steering wheel button for receiving a user input representing a decreased sensitivity amount for the throttle, and decreasing the sensitivity of the throttle based on the user input. In some examples, determining that the park-assist mode for the vehicle is enabled includes at least one of prompting the operator to enable the park-assist mode, or obtaining a setting of the vehicle that indicates whether the park-assist mode is enabled.

In some examples, determining that the operator of the vehicle is performing the parking maneuver is based on one or more inputs representative of one or more of a distance to a neighboring vehicle, an orientation of the vehicle relative to a neighboring vehicle, a position of the vehicle relative to a parking space boundary, a geographic location of the vehicle, a speed of the vehicle, a proximity of the vehicle to at least one of a point-of-interest or a navigation destination, or a gear of the vehicle. In some implementations, the method also includes determining whether the operator provided a user input representing a decreased sensitivity amount for the throttle, based on determining that the operator provided the user input, decreasing the sensitivity of the throttle based on the user input, and, based on determining that the operator did not provide the user input, decreasing the sensitivity of the throttle based on a default decreased sensitivity amount.

In some implementations, the method also includes, based on determining that the park-assist mode for the vehicle is enabled, increasing an autobrake sensitivity. In some examples, the method includes, when the parking maneuver includes navigating the vehicle out of a parking spot, determining a previous gear of the vehicle used to park the vehicle in the parking spot, determining a current gear of the vehicle, and, when the previous gear matches the current gear, alerting the operator that the previous gear matches the current gear, and prompting the operator to confirm the current gear.

In some examples, the method also includes determining, based on a current gear of the vehicle, an intended direction of movement for the vehicle, determining that there is less than a first pre-determined amount of open space in the intended direction of movement and at least a second pre-determined amount of open space opposite the intended direction of movement, and, based on determining that there is less than a first pre-determined amount of open space in the intended direction of movement and at least a second pre-determined amount of open space opposite the intended direction of movement, alerting and prompting the operator to confirm the current gear.

Yet another aspect of the disclosure provides a system including data processing hardware and memory hardware in communication with the data processing hardware. The memory hardware stores instructions that, when executed by the data processing hardware, cause the data processing hardware to perform operations. The operations include determining that an operator of a vehicle is performing a parking maneuver, based on determining that the operator is performing the parking maneuver, determining that a park-assist mode for the vehicle is enabled, and, based on determining that the park-assist mode for the vehicle is enabled, decreasing a sensitivity of a throttle of the vehicle such that the operator has to provide a greater actuation of a throttle actuator to affect a same power of an engine of the vehicle. The engine may be an electric motor or an internal combustion engine.

Implementations of the disclosure may include one or more of the following optional features. In some implementations, the operations also include temporarily designating a steering wheel button for receiving a user input representing a decreased sensitivity amount for the throttle, and decreasing the sensitivity of the throttle based on the user input. In some examples, the operations also include, when the parking maneuver includes navigating the vehicle out of a parking spot, determining a previous gear of the vehicle used to park the vehicle in the parking spot, determining a current gear of the vehicle, and, when the previous gear matches the current gear, alerting the operator that the previous gear matches the current gear, and prompting the operator to confirm the current gear.

### BRIEF DESCRIPTION OF THE DRAWINGS

The drawings described herein are for illustrative purposes only of selected configurations and are not intended to limit the scope of the present disclosure.

FIG. 1 is a view of an example vehicle including a park-assist system in accordance with the principles of the present disclosure.

FIG. 2 is a schematic view of the park-assist system of FIG. 1.

FIG. 3 is a schematic view of an example dashboard gear-selection alert.

FIGS. 4A and 4B are a flowchart of an example arrangement of operations for providing a park-assist mode.

FIG. 5 is a flowchart of another example arrangement of operations for providing a park-assist mode.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Navigating a vehicle in a parking lot or garage can be challenging for an operator of the vehicle due to several factors. For example, confined spaces and narrow lanes often leave little room for maneuvering, making it difficult to execute turns or parking maneuvers (e.g., entering or exiting a parking space). Additionally, navigating a parking lot or garage may require fine throttle control by the operator in order to inch a vehicle forward or backward. Also, with all that the operator has to consider while navigating a parking lot or garage, the operator may inadvertently select a wrong gear. One in five vehicle crashes occur in parking lots and garages, with problems including operators accidentally hitting cars due to lacking the “touch” to effectively navigate parking environments, not applying the ideal force when only trying to inch closer and accidentally being in drive/reverse when the opposite is required. Therefore, there is a need for park-assist systems for helping an operator to navigate parking lots and garages, and to perform parking maneuvers (e.g., entering or exiting a parking space).

While examples are shown and described herein in connection with a vehicle (e.g., an automobile, a truck, an airplane, a train, a motorcycle, etc.), it should be understood that disclosed configurations may additionally, or alternatively, be used for providing parking assistance for any other type of device (e.g., construction equipment, industrial equipment, etc.). Moreover, disclosed configurations may additionally, or alternatively, be used to assist with other types of maneuvers. Furthermore, disclosed configurations may be used with vehicles having any number and/or type(s) of engines including, but not limited to, an internal combustion engine or an electric motor.

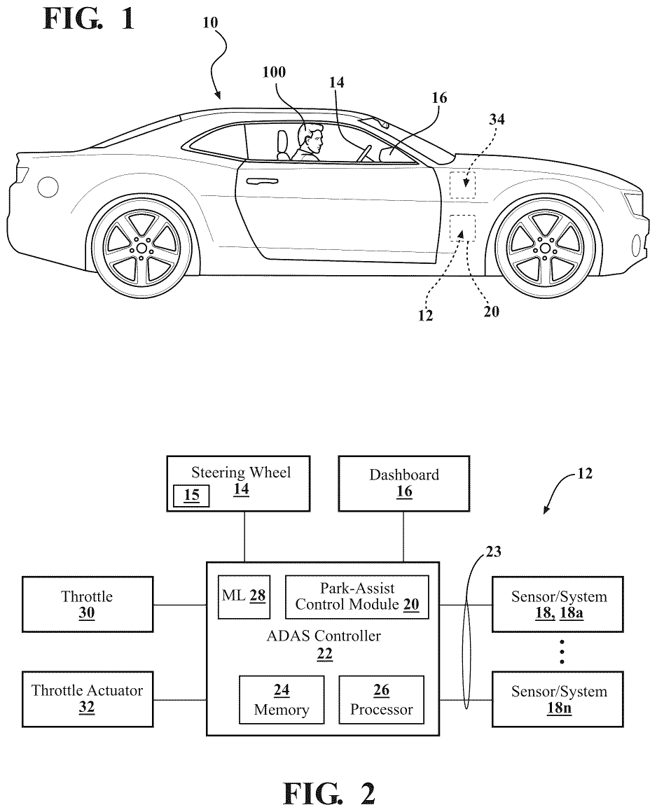

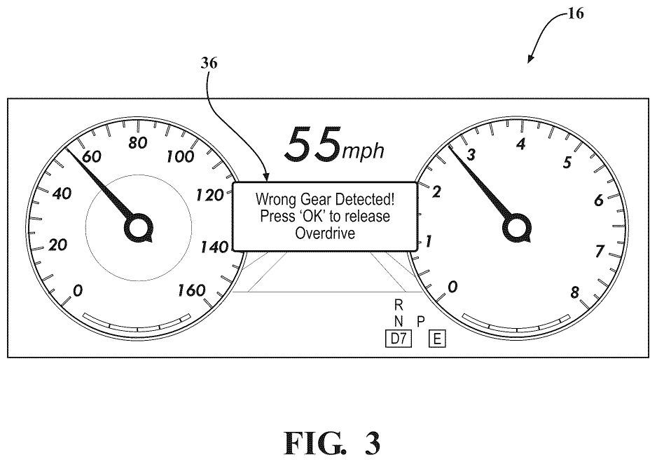

With particular reference to FIGS. 1, 2, and 3, a vehicle 10 (e.g., an automobile, a truck, an airplane, a train, a motorcycle, etc.) is shown in conjunction with a park-assist system 12 for providing parking assistance to an operator 100 of the vehicle 10 during parking maneuvers. Example parking maneuvers include, but are not limited to, entering a parking space and exiting a parking space, which may also be referred to as a parking area, a parking lane, a parking zone, etc. In the illustrated example, the vehicle 10 is controlled, operated, etc. by the operator 100 to perform parking maneuvers or any other maneuvers. The vehicle 10 includes a steering wheel 14 that the operator 100 may use to perform parking or other maneuvers, and a dashboard 16 for displaying information concerning the vehicle 10. In the illustrated example, the steering wheel 14 includes one or more buttons 15 that may be used to control or configure the vehicle 10.

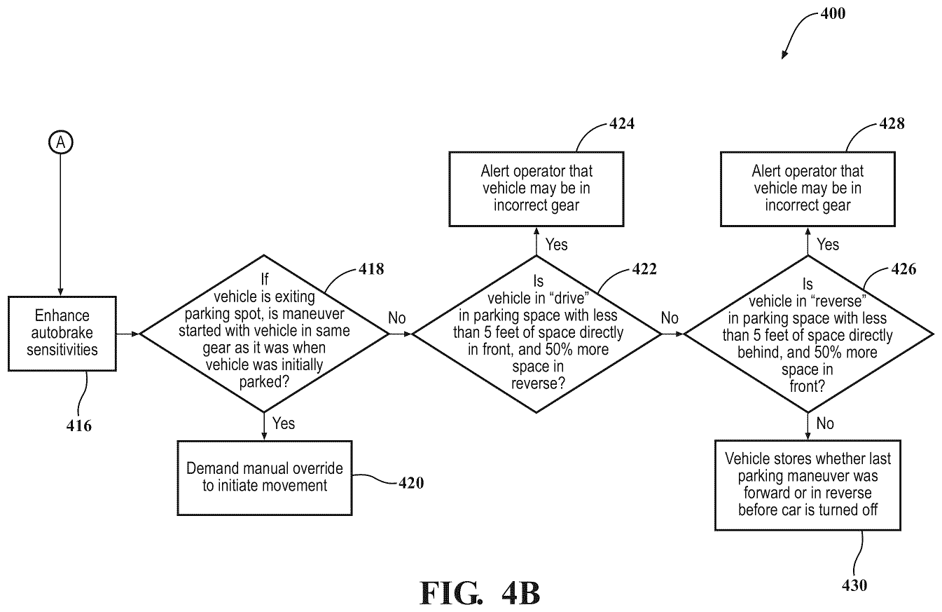

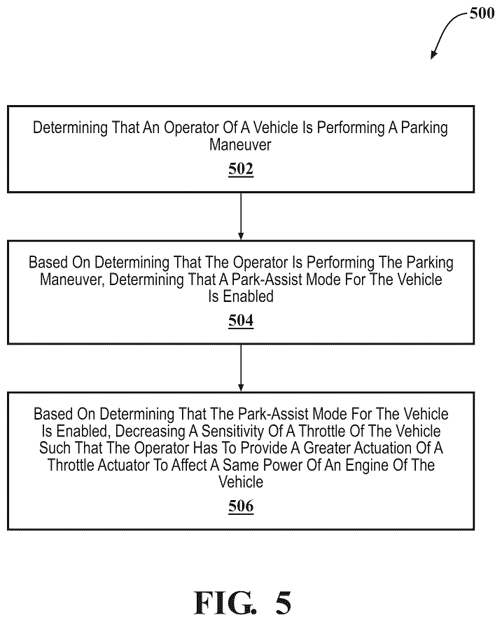

The park-assist system 12 includes a park-assist control module 20 for controlling aspects of the vehicle 10 related to parking maneuvers. The park-assist control module 20 may be executed on, for example, an advanced driver-assistance system (ADAS) controller 22 or any other controller of the vehicle 10. The ADAS controller 22 stores machine-readable instructions for executing the park-assist control module 20 on, for example, memory hardware 24 (e.g., a memory). The instructions may be executed by data processing hardware 26 (e.g., a processor) of the ADAS controller 22 to execute the park-assist control module 20. Here, the park-assist control module 20 may perform the operations shown in FIGS. 4 and 5, or operations described elsewhere in the present disclosure.

In the illustrated example, the ADAS controller 22 receives or obtains one or more inputs 23 from, or using, one or more sensors or systems 18, 18a-n. Example inputs 23 that may be obtained or received from/using the sensors or systems 18 include, but are not limited to, vehicle speed; turn signal switch information; steering wheel angle information; lane and/or traffic control data information; map, route and/or global positioning system (GPS) information; front, side, rear and/or 360 degree image data; front, side, rear and/or 360 degree radar data; inertial measurement unit (IMU) and/or vehicle dynamics information; and navigation system information (e.g., destinations and points of interest (POIs)). The ADAS controller 22 may process the inputs 23 to determine, for example, information related to one or more of a distance to a neighboring vehicle, an orientation of the vehicle 10 relative to a neighboring vehicle, a position of the vehicle 10 relative to a parking space boundary, a geographic location of the vehicle 10, a speed of the vehicle 10, a proximity of the vehicle 10 to at least one of a point-of-interest or a navigation destination, or a gear (e.g., neutral, park, drive, or reverse) of the vehicle 10. The park-assist control module 20 or the ADAS controller 22 processes the information (e.g., a distance to a neighboring vehicle, an orientation of the vehicle 10 relative to a neighboring vehicle, a position of the vehicle 10 relative to a parking space boundary, a geographic location of the vehicle 10, a speed of the vehicle 10, a proximity of the vehicle 10 to at least one of a point-of-interest or a navigation destination, or a gear (e.g., neutral, park, drive, or reverse) of the vehicle 10) to determine whether the operator 100 of the vehicle 10 is performing a parking maneuver. In some implementations, the park-assist control module 20 or the ADAS controller 22 processes the information using a machine-learning (ML) model 28 that is trained to predict, classify, identify, detect, or otherwise determine that the operator 100 is performing a parking maneuver.

When it is determined that the operator 100 is performing a parking maneuver, the park-assist control module 20 determines whether a park-assist mode for the vehicle 10 is enabled. The park-assist control module 20 may determine whether the park-assist mode is enabled by, for example, prompting the operator 100 to provide a user input indicating whether to enable the park-assist mode, or obtaining a setting of the vehicle 10 from the memory 24 that indicates whether the park-assist mode is enabled. Here, the setting of the vehicle 10 may be a default setting or a setting set by an operator 100.

When it is determined that the park-assist mode for the vehicle 10 is enabled, the park-assist control module 20 decreases a sensitivity of a throttle 30 of the vehicle 10 such that the operator 100 has to provide a greater actuation of a throttle actuator 32 (e.g., a pedal, lever, etc.) to affect a same power of an engine 34 (e.g., an internal combustion engine or an electric motor) of the vehicle 10 for propelling the vehicle 10. Here, decreasing the sensitivity of the throttle 30 enables the operator 100 to more precisely control the throttle 30 to, for example, slowly, precisely, smoothly, or carefully inch the vehicle 10 forward and backward by small amounts. In some implementations, the park-assist control module 20 causes a button 15 of the steering wheel 14 to be temporarily designated as a steering wheel button 15 for receiving a user input representing a decreased sensitivity amount for the throttle 30 (e.g., by 30%, 50%, or 70%). For example, the operator 100 may toggle the steering wheel button 15 to select or input a decreased sensitivity amount. Additionally, or alternatively, the park-assist control module 20 may obtain, e.g., from the memory 24, a pre-selected, pre-set, or pre-defined decreased throttle sensitivity amount previously identified or selected by an operator 100, or a default decreased throttle sensitivity amount. The park-assist control module 20 decreases the sensitivity of the throttle 30 based on the obtained decreased throttle sensitivity amount.

In some examples, when a parking maneuver is detected and the park-assist mode is enabled, the park-assist control module 20 also increases a sensitivity of an autobrake function of the ADAS controller 22 to more aggressively or proactively brake to decrease or prevent inadvertent collisions with other vehicles or items in a parking lot or garage.

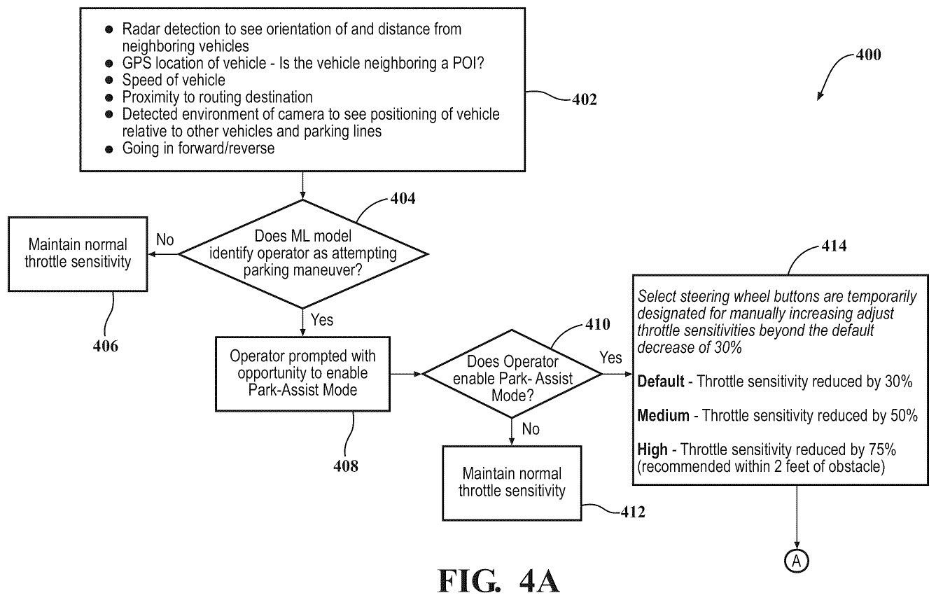

In some implementations, when a detected parking maneuver is navigating the vehicle 10 out of a parking spot, the park-assist control module 20 is configured to determine a previous gear of the vehicle 10 used to park the vehicle 10 in the parking spot, determine a current selected gear of the vehicle 10, and determine whether the previous gear matches the current gear. When the previous gear matches the current gear (e.g., the operator 100 maneuvered the vehicle 10 forward into a park spot and may be inadvertently maneuvering the vehicle 10 forward out of the parking spot), the park-assist control module 20 may be configured to alert the operator 100 that the previous gear matches the current gear, and prompt the operator 100 to confirm or override the current gear. An example dashboard gear-selection alert 36 that may be presented on the dashboard 16 is shown in FIG. 3. In some examples, the current selected gear must be confirmed by the operator 100 prior to the operator 100 being able to maneuver the vehicle 10.

In some implementations, the park-assist control module 20 is configured to determine, based on a current selected gear of the vehicle 10, an intended direction of movement for the vehicle 10, determine whether there is less than a first pre-determined amount of open space (e.g., 5 feet) in the intended direction of movement, and determine whether there is at least a second pre-determined amount of open space (50% more open space than in the direction of travel) opposite the intended direction of movement. Based on determining that there is less than a first pre-determined amount of open space in the intended direction of movement and at least a second pre-determined amount of open space opposite the intended direction of movement, the park-assist control module 20 may be configured to alert and prompt the operator 100 to confirm the current selected gear. An example dashboard gear-selection alert 36 that may be presented on the dashboard 16 is shown in FIG. 3. In some examples, the current selected gear must be confirmed by the operator 100 prior to the operator 100 being able to maneuver the vehicle 10.

FIG. 4 is a flowchart of an example arrangement of operations for providing a park-assist mode. The operations may be performed by data processing hardware (e.g., the data processing hardware 27) based on executing instructions stored on memory hardware (e.g., the memory hardware 24). Many other ways of implementing the method 400 may be employed. For example, the order of execution of the operations may be changed, and/or one or more of the operations and/or interactions may be changed, eliminated, sub-divided, or combined. Additionally, the operations of FIG. 4 may be carried out sequentially and/or in parallel by, for example, separate processing threads, processors, devices, discrete logic, circuits, etc.

At operation 402, the method 400 includes receiving or obtaining one or more inputs 23 from, or using, one or more of the sensors or systems 18. At operation 402, the method 400 includes processing, using the ML 28, the input 23 to determine whether the operator 100 is attempting or performing a parking maneuver. At operation 406, if a parking maneuver is not detected at operation 404, the method 400 includes maintaining normal throttle sensitivity.

At operation 408, if a parking maneuver is detected at operation 404, the method 400 includes prompting the operator 100 to enable park-assist mode. At operation 410, the method 400 includes determining whether park-assist mode is enabled. At operation 412, if park-assist mode is not enabled, the method 400 includes maintaining normal throttle sensitivity.

At operation 414, if park-assist mode is enabled, the method 400 includes receiving a user input via a steering wheel button 15 representing a decreased throttle sensitivity amount, and setting throttle sensitivity based on the user input. At operation 416, the method 400 includes increasing an autobrake sensitivity.

At operation 418, the method 400 includes determining whether the vehicle 10 is exiting a parking spot using the same gear selection used to park the vehicle 10. At operation 420, if the same gear is being used, the method 400 includes prompting the operator 100 for a manual gear selection override before initiating movement.

At operation 422, the method 400 determines whether the vehicle 10 is in drive in a parking space with less than 5 feet of space in front of the vehicle 10 and 50% more space behind the vehicle 10. At operation 424, when the vehicle 10 is in drive in a parking space with less than 5 feet of space in front of the vehicle 10 and 50% more space behind the vehicle 10, the method 400 includes alerting the operator 100 that the vehicle 10 may be in an incorrect gear.

At operation 426, the method 400 determines whether the vehicle 10 is in reverse in a parking space with less than 5 feet of space behind the vehicle 10 and 50% more space in front of the vehicle 10. At operation 428, when the vehicle 10 is in reverse in a parking space with less than 5 feet of space behind the vehicle 10 and 50% more space in front of the vehicle 10, the method 400 includes alerting the operator 100 that the vehicle 10 may be in an incorrect gear.

At operation 430, when the parking maneuver is completed, the method 400 includes storing the last gear used to park the vehicle 10.

FIG. 5 is a flowchart of another example arrangement of operations for providing a park-assist mode. The operations may be performed by data processing hardware (e.g., the data processing hardware 27) based on executing instructions stored on memory hardware (e.g., the memory hardware 24). Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

At operation 502, the method 500 includes determining whether an operator 100 of a vehicle 10 is performing a parking maneuver. At operation 504, the method 500 includes, based on determining that the operator 100 is performing the parking maneuver, determining whether a park-assist mode for the vehicle 10 is enabled. At operation 506, the method 500 includes, based on determining that the park-assist mode for the vehicle is enabled, decreasing a sensitivity of a throttle 30 of the vehicle 10 such that the operator 100 has to provide a greater actuation of a throttle actuator 32 to affect a same power of an engine 34 of the vehicle 10.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an engine comprising an internal combustion engine or an electric motor;
a throttle;
a throttle actuator configured to, responsive to user input from an operator of the vehicle, control the throttle to adjust a power of the engine for propelling the vehicle;
a steering wheel button;
data processing hardware; and
memory hardware in communication with the data processing hardware and storing instructions that, when executed by the data processing hardware, cause the data processing hardware to perform operations comprising:
determining that the operator is performing a parking maneuver;
based on determining that the operator is performing the parking maneuver, determining that a park-assist mode for the vehicle is enabled for the parking maneuver; and
based on determining that the park-assist mode for the vehicle is enabled for the parking maneuver:
temporarily designating the steering wheel button for receiving a manual user input representing an amount of throttle sensitivity decrease for the throttle for the parking maneuver;
receiving, using the temporarily designated steering wheel button, from the operator, the manual user input representing the amount of throttle sensitivity decrease; and
decreasing a sensitivity of the throttle by the manually-input amount of throttle sensitivity decrease such that the operator has to provide a greater actuation of the throttle actuator to affect a same power of the engine while performing the parking maneuver.

2. (canceled)

3. The vehicle of claim 1, wherein determining that the park-assist mode for the vehicle is enabled comprises at least one of:
prompting the operator to enable the park-assist mode; or
obtaining a setting of the vehicle that indicates whether the park-assist mode is enabled.

4. The vehicle of claim 1, wherein determining that the operator of the vehicle is performing the parking maneuver is based on one or more inputs representative of one or more of:
a distance to a neighboring vehicle;
an orientation of the vehicle relative to a neighboring vehicle;
a position of the vehicle relative to a parking space boundary;
a geographic location of the vehicle;
a speed of the vehicle;
a proximity of the vehicle to at least one of a point-of-interest or a navigation destination; or
a gear of the vehicle.

5. The vehicle of claim 4, wherein determining that the operator of the vehicle is performing the parking maneuver comprises:
obtaining the one or more inputs using one or more sensors of the vehicle; and
processing, using a machine learning (ML) model, the one or more inputs to determine whether the operator is performing the parking maneuver.

6. The vehicle of claim 1, wherein the operations further comprise:
determining that the operator did not provide the manually-input amount of throttle sensitivity decrease using the temporarily designated steering wheel button; and
based on determining that the operator did not provide the manually-input amount of throttle sensitivity decrease using the temporarily designated steering wheel button, decreasing the sensitivity of the throttle by a default throttle sensitivity decrease for the parking maneuver.

7. The vehicle of claim 1, wherein the operations further comprise, based on determining that the park-assist mode for the vehicle is enabled, increasing an autobrake sensitivity.

8. The vehicle of claim 1, wherein the operations further comprise, when the parking maneuver comprises navigating the vehicle out of a parking spot:
determining a previous gear of the vehicle used to park the vehicle in the parking spot;
determining a current gear of the vehicle; and
when the previous gear matches the current gear:
alerting the operator that the previous gear matches the current gear; and
prompting the operator to confirm the current gear.

9. The vehicle of claim 1, wherein the operations further comprise:
determining, based on a current gear of the vehicle, an intended direction of movement for the vehicle;
determining that there is less than a first pre-determined amount of open space in the intended direction of movement and at least a second pre-determined amount of open space opposite the intended direction of movement; and
based on determining that there is less than a first pre-determined amount of open space in the intended direction of movement and at least a second pre-determined amount of open space opposite the intended direction of movement, alerting and prompting the operator to confirm the current gear.

10. A method comprising:
determining that an operator of a vehicle is performing a parking maneuver;
based on determining that the operator is performing the parking maneuver, determining that a park-assist mode for the vehicle is enabled for the parking maneuver; and
based on determining that the park-assist mode for the vehicle is enabled for the parking maneuver:
temporarily designating a steering wheel button of the vehicle for receiving a manual user input representing an amount of throttle sensitivity decrease for a throttle of the vehicle for the parking maneuver;
receiving, using the temporarily designated steering wheel button, from the operator, the manual user input representing the amount of throttle sensitivity decrease; and
decreasing a sensitivity of the throttle of the vehicle by the manually-input amount of throttle sensitivity decrease such that the operator has to provide a greater actuation of a throttle actuator of the vehicle to affect a same power of an engine of the vehicle while performing the parking maneuver, the engine comprising an internal combustion engine or an electric motor.

11. (canceled)

12. The method of claim 10, wherein determining that the park-assist mode for the vehicle is enabled comprises at least one of:
prompting the operator to enable the park-assist mode; or
obtaining a setting of the vehicle that indicates whether the park-assist mode is enabled.

13. The method of claim 10, wherein determining that the operator of the vehicle is performing the parking maneuver is based on one or more inputs representative of one or more of:
a distance to a neighboring vehicle;
an orientation of the vehicle relative to a neighboring vehicle;
a position of the vehicle relative to a parking space boundary;
a geographic location of the vehicle;
a speed of the vehicle;
a proximity of the vehicle to at least one of a point-of-interest or a navigation destination; or
a gear of the vehicle.

14. The method of claim 10, further comprising:
determining that the operator did not provide the manually-input amount of throttle sensitivity decrease using the temporarily designated steering wheel button; and
based on determining that the operator did not provide the manually-input amount of throttle sensitivity decrease using the temporarily designated steering wheel button, decreasing the sensitivity of the throttle by a default throttle sensitivity decrease for the parking maneuver.

15. The method of claim 10, further comprising, based on determining that the park-assist mode for the vehicle is enabled, increasing an autobrake sensitivity.

16. The method of claim 10, further comprising, when the parking maneuver comprises navigating the vehicle out of a parking spot:
determining a previous gear of the vehicle used to park the vehicle in the parking spot;
determining a current gear of the vehicle; and
when the previous gear matches the current gear:
alerting the operator that the previous gear matches the current gear; and
prompting the operator to confirm the current gear.

17. The method of claim 10, further comprising:
determining, based on a current gear of the vehicle, an intended direction of movement for the vehicle;
determining that there is less than a first pre-determined amount of open space in the intended direction of movement and at least a second pre-determined amount of open space opposite the intended direction of movement; and
based on determining that there is less than a first pre-determined amount of open space in the intended direction of movement and at least a second pre-determined amount of open space opposite the intended direction of movement, alerting and prompting the operator to confirm the current gear.

18. A system comprising:
data processing hardware; and
memory hardware in communication with the data processing hardware and storing instructions that, when executed by the data processing hardware, cause the data processing hardware to perform operations comprising:
determining that an operator of a vehicle is performing a parking maneuver;
based on determining that the operator is performing the parking maneuver, determining that a park-assist mode for the vehicle is enabled for the parking maneuver; and
based on determining that the park-assist mode for the vehicle is enabled for the parking maneuver:
temporarily designating a steering wheel button of the vehicle for receiving a manual user input representing an amount of throttle sensitivity decrease for a throttle of the vehicle for the parking maneuver;
receiving, using the temporarily designated steering wheel button, from the operator, the manual user input representing the amount of throttle sensitivity decrease; and
decreasing a sensitivity of the throttle of the vehicle by the manually-input amount of throttle sensitivity decrease such that the operator has to provide a greater actuation of a throttle actuator of the vehicle to affect a same power of an engine of the vehicle while performing the parking maneuver, the engine comprising an internal combustion engine or an electric motor.

19. (canceled)

20. The system of claim 18, wherein the operations further comprise, when the parking maneuver comprises navigating the vehicle out of a parking spot:
determining a previous gear of the vehicle used to park the vehicle in the parking spot;
determining a current gear of the vehicle; and
when the previous gear matches the current gear:
alerting the operator that the previous gear matches the current gear; and
prompting the operator to confirm the current gear.

21. The vehicle of claim 1, wherein the manually-input amount of throttle sensitivity decrease is selected, using the temporarily designated steering wheel button, from a pre-defined set of threshold sensitivity decrease amounts.

22. The method of claim 10, wherein the manually-input amount of throttle sensitivity decrease is selected, using the temporarily designated steering wheel button, from a pre-defined set of threshold sensitivity decrease amounts.

23. The system of claim 18, wherein the manually-input amount of throttle sensitivity decrease is selected, using the temporarily designated steering wheel button, from a pre-defined set of threshold sensitivity decrease amounts.
